(19) United States
(12) Patent Application Publication
(10) Pub. No.: US 2015/0160406 A1
(43) Pub. Date: Jun. 11, 2015

(54) BACKLIGHT MODULE AND LIQUID CRYSTAL DISPLAY DEVICE USING THE SAME

(71) Applicants: Gege Zhou, Shenzhen (CN); Gang Yu, Shenzhen (CN); Jiaqiang Wang, Shenzhen (CN)

(72) Inventors: Gege Zhou, Shenzhen (CN); Gang Yu, Shenzhen (CN); Jiaqiang Wang, Shenzhen (CN)

(73) Assignee: Shenzhen China Star Optoelectronics Technology Co. Ltd., Shenzhen (CN)

(21) Appl. No.: 13/703,368

(22) PCT Filed: Aug. 30, 2012
(86) PCT No.: PCT/CN2012/080804

§ 371 Date: Dec. 11, 2012

(30) Foreign Application Priority Data
Aug. 15, 2012 (CN) 201210290394.X

(51) Int. Cl. F21V 8/00

(52) U.S. Cl. CPC G02B 6/0088; G02B 6/009

(57) ABSTRACT

A backlight module used in a liquid crystal display (LCD) device is proposed. The backlight module includes a light source, a back bezel, a light guide plate (LGP), and an optical film. The light source is used for emitting light. The back bezel includes a bearing surface and at least one side. The back bezel is used for bearing the light source with the bearing surface. The LGP is disposed on the light source for guiding the light. The optical film disposed on the LGP is used for dealing with the light guided by the LGP. The optical film includes at least one curved portion. The curved portion is connected to the side of the back bezel for securing the position of the optical film relative to the other components.

### BACKGROUND OF THE INVENTION

1. Field of the Invention

The present invention relates to a backlight module and a liquid crystal display (LCD) device using the same, and more particularly, to a backlight module comprising a narrower bezel and an LCD device using the same.

2. Description of the Prior Art

LCDs are widely used in modern information equipments such as computers, cell phones, personal digital assistances (PDAs), etc, due to their thin, lightweight, low power consumption features. Generally, an LCD comprises a liquid crystal panel and a backlight module. Since the liquid crystal panel itself does not light, the LCD requires light sources which emit light from the backlight module. Light emitted by the backlight modules passes through liquid crystals in the liquid crystal panel. The intensity of light which would be conveyed to a viewer is adjusted by means of an alignment of the liquid crystals. Subsequently, images are produced.

According to the location of light sources, the backlight module of the LCD device is classified as a side-light type and a direct-light type. For the side-light type backlight module, light sources illuminate the LCD from the side of the display panel. Light produced by the light sources emits to the liquid crystal panel. For the direct-light type backlight module, light sources illuminate the LCD from the bottom of the display panel. Light produced by the light sources emits to the liquid crystal panel.

Refer to FIG. 1 showing a schematic diagram illustrating a conventional LCD device 100. The LCD device 100 comprises a liquid crystal panel 110, a frame 120, and a backlight module 130. The backlight module 130 comprises a housing 131, an optical film 132, a light guide plate (LGP) 133, a light source 134, and a back bezel 135.

The back bezel 135 comprises a bearing surface. The bearing surface is used for bearing the light source 134. The LGP 133 is disposed on the light source 134 and used for guiding the light emitted by the light source 134. The optical film 132 is disposed on the LGP 133 for dealing with the light guided by the LGP 133. The housing 131 is disposed on the optical film 132 and used for compressing the optical film 132 for securing the position of the optical film 132 relative to other components.

The liquid crystal panel 110 is disposed on the housing 131. The intensity of light conveyed to a viewer is adjusted for producing images by means of the light emitted by the backlight module 130 and the alignment of liquid crystals in the liquid crystal panel 110.

The frame 120 is used for securing the position of the liquid crystal panel 110 relative to the other components.

Because the housing 131 needs to compress the optical film 132 in this structure, the width of the sides of the optical film 132 and the width of the housing 131 need to be large enough to secure the optical film 132.

But LCD devices have become more and more chic and fashionable in recent years. They have one characteristic of a narrow bezel. It implies that the width of a housing should be small to conform to the narrow bezel design. However, the width of the above-mentioned housing 131 is comparably large. It means that the housing 131 could not satisfy the LCD device comprising the narrow bezel.

Therefore, another method needs to be proposed for solving the above-mentioned problem.

### SUMMARY OF THE INVENTION

An object of the present invention is to provide a backlight module and an LCD device using the same. The present invention proposes a narrow-edge frame design for a backlight module.

According to the present invention, a backlight module used in a liquid crystal display (LCD) device, comprises: a light source, for emitting light; a back bezel, comprising a bearing surface and at least one side, the back bezel bearing the light source with the bearing surface; a light guide plate (LGP), disposed on the light source, for guiding the light; and an optical film, for dealing with the light guided by the LGP, the optical film disposed on the LGP and comprising at least one curved portion, and the curved portion connected to the side of the back bezel for securing a position of the optical film relative to other components.

In one aspect of the present invention, the curved portion is connected to the back bezel with a double-sided tape or a screw, for securing the position of the optical film relative to the other components.

In another aspect of the present invention, the back bezel comprises four sides, the optical film comprises four curved portions, and the curved portions of the optical film are connected to the sides of the back bezel, for securing the position of the optical film relative to the other components.

In still another aspect of the present invention, the curved portion is connected to the back bezel with a double-sided tape or a screw, for securing the position of the optical film relative to the other components.

In yet another aspect of the present invention, each of the curved portions is 90 degrees.

According to the present invention, an LCD device comprises: a liquid crystal panel; and a backlight module. The backlight module comprises: a light source, for emitting light; a back bezel, comprising a bearing surface and at least one side, the back bezel bearing the light source with the bearing surface; an LGP, disposed on the light source, for guiding the light; and an optical film, for dealing with the light guided by the LGP, the optical film disposed on the LGP and comprising at least one curved portion, the curved portion connected to the side of the back bezel for securing a position of the optical film relative to other components.

In one aspect of the present invention, the curved portion is connected to the back bezel with a double-sided tape or a screw, for securing the position of the optical film relative to the other components.

In another aspect of the present invention, the back bezel comprises four sides, the optical film comprises four curved portions, and the curved portions of the optical film are connected to the sides of the back bezel, for securing the position of the optical film relative to the other components.

In still another aspect of the present invention, each of the curved portions is 90 degrees.

In yet another aspect of the present invention, the backlight module further comprises a housing disposed on the optical film, and the housing is used for compressing the optical film and preventing light leakage.

The present invention has the following benefit: The optical film comprises the curved portions. The curved portions are connected to the sides of the back bezel for securing the position of the optical film relative to other components. That is, the optical film is not compressed by the housing, which implies that the width of the sides of the optical film, the width of the housing, or even the width of the frame could become smaller: Thus, the narrow bezel design succeeds.

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 is a schematic diagram illustrating a conventional LCD device.

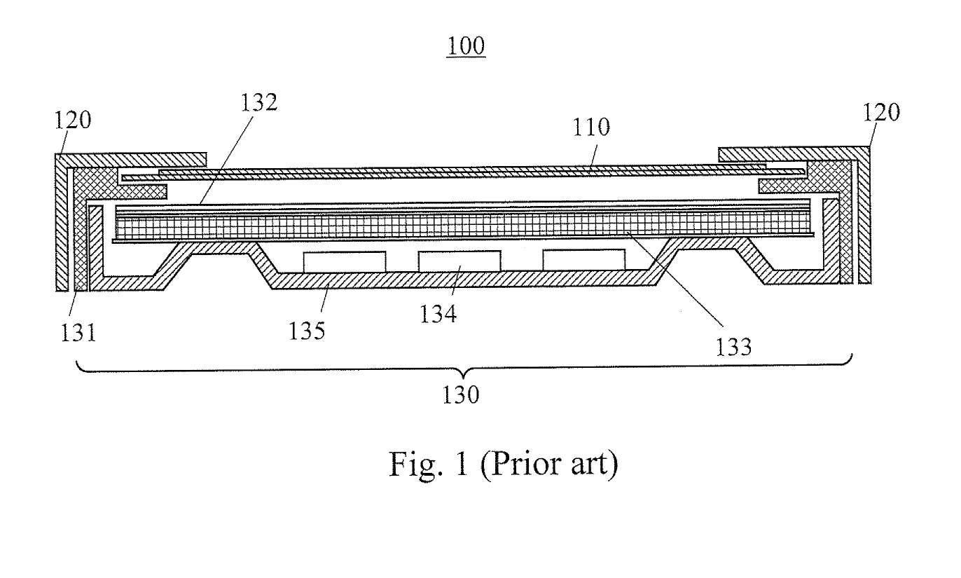

FIG. 2 is a schematic diagram illustrating an LCD device according to an embodiment of the present invention.

### DETAILED DESCRIPTION OF THE PREFERRED EMBODIMENTS

The above and other objects, features and advantages of the present invention will be more apparent from the following detailed description taken in conjunction with the accompanying drawings. It is obvious that this embodiment is one of the embodiments in the present invention. From this teaching the skilled person may find other embodiments to realize the teaching of the present invention without applying additional inventive activity. These embodiments are still under the scope of the present claims.

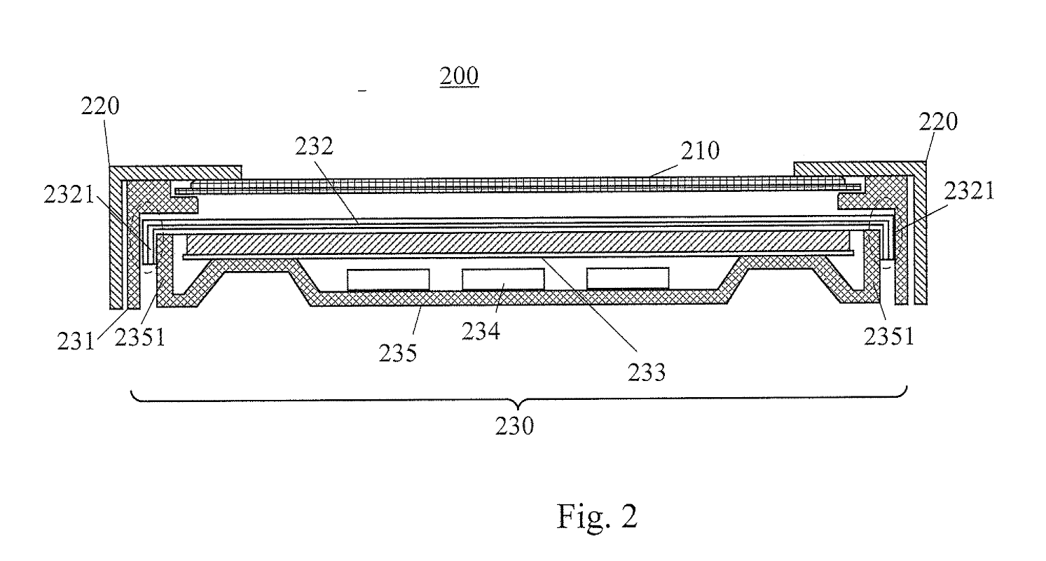

Refer to FIG. 2 showing a schematic diagram illustrating an LCD device 200 according to one embodiment of the present invention. The LCD device 200 comprises a liquid crystal panel 210, a frame 220, and a backlight module 230. The backlight module 230 comprises a housing 231, an optical film 232, a light guide plate (LGP) 233, a light source 234, and a back bezel 235.

The back bezel 235 comprises a bearing surface and four sides 2351. It is worth noting that FIG. 2 is a side view so only two sides 2351 are shown. In fact, the back bezel 235 comprises four sides 2351 in practical applications. The back bezel 235 is used for bearing the light source 234 with the bearing surface. The light source 234 is used for emitting light. The LGP 233 is disposed on the light source 234 for guiding the light emitted by the light source 234. The optical film 232 is disposed on the LGP 233 for dealing with the light guided by the LGP 233. The housing 231 is disposed on the optical film 232 for compressing the optical film 232 and preventing the light from being leaked.

The optical film 232 further comprises four curved portions 2321 in this embodiment. (Since FIG. 2 is a side view, only two curved portions 2321 are shown. In fact, the optical film 232 comprises four curved portions 2321 in practical applications.) The curved portions 2321 are marked by dotted lines.

It is worth noting that the curved portions 2321 are used for securing the position of the optical film 232 relative to other components. The curved portions 2321 are connected to the sides 2351 in this embodiment. So the position of the optical film 232 relative to the other components is secured. Preferably, each of the curved portions 2321 is 90 degrees so that the curved portions 2321 could firmly touch the sides 2351. It is worth noting that there is no limitation on the method for connecting the curved portions 2321 to the sides 2351. For example, the curved portions 2321 are glued to the sides 2351 with a double-sided tape. Or, the curved portions 2321 are connected to the sides 2351 with a screw. Certainly, other components could be used for connecting the curved portions 2321 to the sides 2351, which is within the scope of the present invention.

In addition, it is worth noting that there is no limitation on the number of the sides 2351 of the back bezel 235 and the curved portions 2321 of the optical film 232 in the present invention. There is also no limitation on the number of the joints between the sides 2351 and the curved portions 2321; that is, the number of the joints between the sides 2351 and the curved portions 2321 could be more or less. Or, it is permissible that some of the sides 2351 are connected to some of the curved portions 2321. In conclusion, as long as the sides 2351 of the back bezel 235 could be connected to the curved portions 2321 of the optical film 232 for securing the position of the optical film 232 relative to the other components, it is within the scope of the present invention.

The liquid crystal panel 210 is disposed on the housing 231. The intensity of light conveyed to a viewer is adjusted for producing images by means of the light emitted by the backlight module 230 and the alignment of liquid crystals in the liquid crystal panel 210.

The frame 220 is used for fixing the position of the liquid crystal panel 210 relative to the other components.

It is worth noting that the optical film. 232 is not compressed by the housing 231 in the present invention, unlike the conventional technology. The housing 231 simply assists the settlement of the optical film 232. Therefore, it is more flexible to adjust the width of the sides 2351 of the optical film 232, the width of the housing 231, or even the width of the frame 220. In other words, the width of the sides 2351 of the optical film 232, the housing 231, and the frame 220 would be smaller for securing the position of the optical film 232.

Compared with the conventional technology, the optical film 232 comprises the curved portions 2321. The curved portions 2321 are connected to the sides 2351 of the back bezel 235 for fixing the position of the optical film 232 relative to the other components. To put it differently, the optical film 232 is not compressed by the housing 231, which implies that the width of the sides 2351 of the optical film 232, the width of the housing 231, or even the width of the frame 220 could become smaller. Thus, the narrow bezel design for the backlight module 230 is achieved.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A backlight module used in a liquid crystal display (LCD) device, comprising:
a light source, for emitting light;
a back bezel, comprising a bearing surface and at least one side, the back bezel bearing the light source with the bearing surface;
a light guide plate (LGP), disposed on the light source, for guiding the light; and
an optical film, for dealing with the light guided by the LGP, the optical film disposed on the LGP and comprising at least one curved portion, and the curved portion connected to the side of the back bezel for securing a position of the optical film relative to other components.

2. The backlight module of claim 1, wherein the curved portion is connected to the back bezel with a double-sided tape or a screw, for securing the position of the optical film relative to the other components.

3. The backlight module of claim 1, wherein the back bezel comprises four sides, the optical film comprises four curved portions, and the curved portions of the optical film are connected to the sides of the back bezel, for securing the position of the optical film relative to the other components.

4. The backlight module of claim 3, wherein the curved portion is connected to the back bezel with a double-sided tape or a screw, for securing the position of the optical film relative to the other components.

5. The backlight module of claim 3, wherein each of the curved portions is 90 degrees.

6. An LCD device, comprising:
a liquid crystal panel; and
a backlight module, comprising:
a light source, for emitting light;
a back bezel, comprising a bearing surface and at least one side, the back bezel bearing the light source with the bearing surface;
an LGP, disposed on the light source, for guiding the light; and
an optical film, for dealing with the light guided by the LGP, the optical film disposed on the LGP and comprising at least one curved portion, the curved portion connected to the side of the back bezel for securing a position of the optical film relative to other components.

7. The LCD device of claim 6, wherein the curved portion is connected to the back bezel with a double-sided tape or a screw, for securing the position of the optical film relative to the other components.

8. The LCD device of claim 6, wherein the back bezel comprises four sides, the optical film comprises four curved portions, and the curved portions of the optical film are connected to the sides of the back bezel, for securing the position of the optical film relative to the other components.

9. The LCD device of claim 7, wherein each of the curved portions is 90 degrees.

10. The LCD device of claim 6, wherein the backlight module further comprises a housing disposed on the optical film, and the housing is used for compressing the optical film and preventing light leakage.
